(19) United States
(12) Patent Application Publication
(10) Pub. No.: US 2011/0017625 A1
(43) Pub. Date: Jan. 27, 2011

(54) Cubic eco-package for liquid products with finger engageable pull

(75) Inventor: Jeffrey Wycoff, Boulder, CO (US)

Correspondence Address: CR MILES, P.C.;CRAIG R. MILES, 405 MASON COURT, SUITE 119, FORT COLLINS, CO, 80524, US

(73) Assignee: Simplicity Products International, Inc.

(21) Appl. No.: 12/804,556

(22) Filed: Jul. 22, 2010

Related U.S. Application Data
(60) Provisional application No. 61/271,539, filed on Jul. 22, 2009.
(60) Provisional application No. 61/278,752, filed on Oct. 9, 2009.

(51) Int. Cl. B65D 85/00; B65D 25/28; B65D 21/036; B65D 6/02; B23P 11/00

(52) U.S. Cl. 206/459.5; 220/771; 206/508; 220/660; 29/428

(57) ABSTRACT

A cubic container for a liquid product having a generally square base joined to four sides which extend upwardly to join a generally square top defines an internal volume of a generally cubic container body. A portion of one corner of the container and a pass through aperture defines a generally vertical handle. The handle having a hollow interior which communicates with the internal volume of the container has an external surface configured to be grasped by a hand located in the pass through aperture. An opening in the top of the cubic container body provides a passage through which the liquid product can be poured. A cap releasably sealably engages the opening to close the cubic container.

This United States Non-Provisional patent application claims priority to U.S. Design patent application No. 29/345,205, filed Oct. 12, 2009, and the benefit of U.S. Provisional Patent Application Nos. 61/271,539, filed Jul. 22, 2009, and 61/278,752, filed Oct. 9, 2009, each hereby incorporated by reference herein.

### I. FIELD OF THE INVENTION

A cubic container for a liquid product having a generally square base joined to four sides which extend upwardly to join a generally square top defines an internal volume of a generally cubic container body. The intersection of two sides of the container body and a pass-through aperture defines a generally vertical handle. The handle having a hollow interior which communicates with the internal volume of the container has an external surface configured to be grasped by a portion of a hand located in the pass-through aperture. An opening in the top of the cubic container body provides a passage through which a liquid product can be poured. A cap releasably sealably engages the opening to close the cubic container.

### II. BACKGROUND

Conventional containers for liquid products typically provide a container body having a closed end and an open end which receives a cap. As shown for example by FIG. 18, the configuration of a conventional container body between the closed end and the open end provides two major faces which comprise the rear side and the front side of the container body and provide two minor faces which comprise the sides of the container body. The sides of the conventional container typically upwardly inwardly curve to terminate in the configuration of the open end. The curvature of the sides define an asymmetrical boundary of the front side and rear side of the conventional container. The front side and back side of the conventional container may be imprinted directly, or indirectly with imprinted appliqués or labels, with product information. A portion of one side of the conventional container body may provide a pass-through handle having a hollow interior passage which communicates with the internal volume of the container body.

A substantial problem with conventional containers for liquid products may be the relatively large per unit horizontal shelf length allocated to the conventional container body. The per unit allocation may be relatively high when the container body affords two major faces and two minor faces. Typically, one of the major faces imprinted with product information faces the front of the shelf for presentation to the consumer while the minor faces are disposed in horizontal adjacent relation. A certain number of repetitions of the product information imprinted on the major face may be required to attract the attention of the customer. The amount of horizontal shelf space allocated to a given container body may be fixed by the number of repetitions of the product information necessary to gain the consumers attention. There would be an advantage if the number of container bodies disposed in an amount of horizontal shelf space could be increased while the imprintable surface area on the container body (also referred to as the “billboard”) remained the same, or if the number of container bodies disposed in horizontal relation on a shelf remained the same but afforded a larger billboard to attract consumers.

Another substantial problem with conventional containers which have two major faces and two minor faces may be a substantial dimensional asymmetry between faces which define the configuration of the external and internal volume of the container body which places the center of mass sufficiently distant from the handle to make control of the container or pouring liquid product from the container difficult. There would be an advantage if the configuration of the container placed the center of mass of the container and the contents of the container closer to the handle to reduce the amount of force applied to the handle to place the container (or container with contents) in motion, to put the container at rest, or control the directional travel of the container.

Another substantial problem with conventional containers with integral handles of fixed location which are stored or displayed on shelving can be that the handle is turned toward the back of the shelf and unavailable as a grip for removal of the container body from the shelf. As one example, the side of the container body on which the handle occurs may not provide as large a billboard on which to imprint product information or affix labels as the side of the container on which the handle does not occur. The container body may then be positioned on shelves or in other storage or display units to present the billboard of greatest area to the consumer. This may necessitate locating the handle of the container away from the consumer. When a plurality of such containers are placed adjacent on a shelf, the handle may not be available to grip at all. There would be an advantage if the container provided an alternate grip or pull in the event the handle was not accessible.

Another substantial problem with conventional product packaging may be that the amount of raw material for production of the container body and cap may be relatively high when the container body affords two major faces and two minor faces. There would be an advantage if the configuration of a container body defined an internal volume which was the same or greater as compared to conventional container bodies but required a substantially lesser amount of raw material for production.

A related substantial problem with conventional product packaging may be that the amount of overwrap such as paperboard, cardboard, plastic wrap, or the like may be relatively high when the container body affords two major faces and two minor faces. There would be an advantage if the configuration of the container body afforded the same or similar volume and same number of container bodies could be overwrapped with less material.

The inventive cubic container for liquid products addresses each of these substantial problems.

### III. SUMMARY OF THE INVENTION

Accordingly, a broad object of the invention can be to provide embodiments of a container having a generally cubic configuration as hereafter described and shown in the Figures which locates the center of mass of the container (and any contents of the container), closer to the handle to reduce the amount of force which must be applied to place the container (or container with contents) in motion, to put the container at rest, or control the directional travel of the container.

Another broad object of particular embodiments of the invention can be to provide a billboard on the external surface of a cubic container body which has substantially the same or greater area as compared to conventional containers which hold the same or similar amount of liquid product while utilizing less horizontal space when a plurality of the cubic containers are placed side by side.

Another broad object of the invention can be to provide embodiments of the cubic container and an eco-package which utilizes a lesser amount of raw materials for the container body and overwrap.

Naturally, further objects of the invention are disclosed throughout other areas of the specification, drawings, photographs, and claims.

### IV. A BRIEF DESCRIPTION OF THE DRAWINGS

FIG. 1 is a perspective elevation view of a particular embodiment of the inventive cubic container.

FIG. 2 is a perspective elevation view of the particular embodiment of the inventive cubic container opposite the side shown by FIG. 1.

FIG. 3 is perspective top view of the particular embodiment of the inventive cubic container shown in FIG. 1.

FIG. 4 is a top plan view of the particular embodiment of the inventive cubic container shown in FIG. 1.

FIG. 5 is an elevation view of the particular embodiment of the inventive cubic of FIG. 1 which provides a side view of the handle.

FIG. 6 is an elevation view of the particular embodiment of the inventive cubic container shown in FIG. 1.

FIG. 7 is an elevation view of the particular embodiment of the inventive cubic container shown in FIG. 1 opposite the side shown by FIG. 67.

FIG. 8 is a bottom perspective view a particular embodiment of the inventive cubic container which further includes a base recess element configured to receive the cap of a second cubic container upon stacking.

FIG. 9 is a perspective top view of a particular embodiment of the inventive cubic container having the opening and cap located off center.

FIG. 10 is a top perspective view of an embodiment of the inventive cubic container shown in FIG. 9 further including a particular embodiment of a finger engageable pull.

FIG. 11 is a plan view of the embodiment of the finger engageable pull shown in FIG. 10.

FIG. 12 is an end view of the embodiment of a finger engageable pull shown in FIG. 11.

FIG. 13 is a side view of the embodiment of a finger engageable pull shown in FIG.

FIG. 14 is the opposite side view of the embodiment of a finger engageable pull shown in FIG. 12.

FIG. 15 is the opposite end view of the embodiment of a finger engageable pull shown in FIG. 12.

FIG. 16 is an elevation view of the embodiment of the inventive cubic container shown in FIG. 9 with the cap removed to expose a particular embodiment of a pour spout.

FIG. 17 is an elevation view of the particular embodiment of the inventive cubic container which further shows a liquid product contained within and a portion of a shipping container in which a plurality of the inventive containers can be shipped.

FIG. 18 is an illustration of a plurality of conventional containers in horizontal adjacent relation with the sides of greater area facing outwardly for presentation.

FIG. 19 is an illustration of a plurality of an embodiment of the inventive cubic container in horizontal adjacent relation with the sides of greater area facing outwardly for presentation.

FIG. 20 is an illustration which compares the particular embodiment of the invention of FIG. 1 with a conventional container to show the difference in the pouring axis and center of mass.

### V. DETAILED DESCRIPTION OF THE PREFERRED EMBODIMENTS

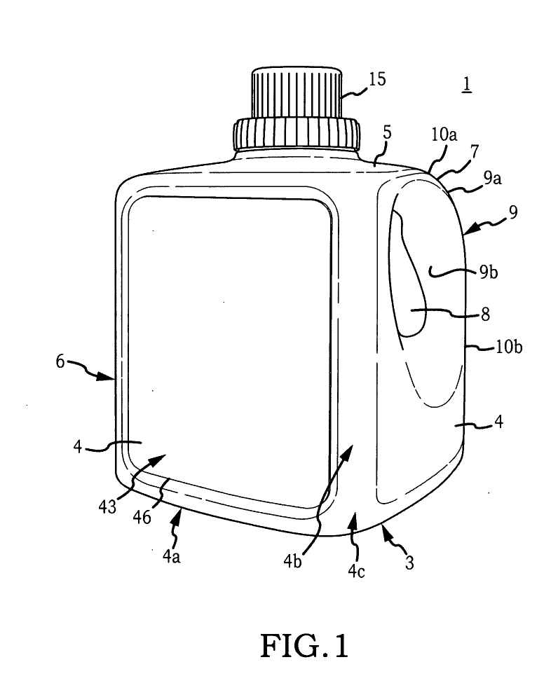

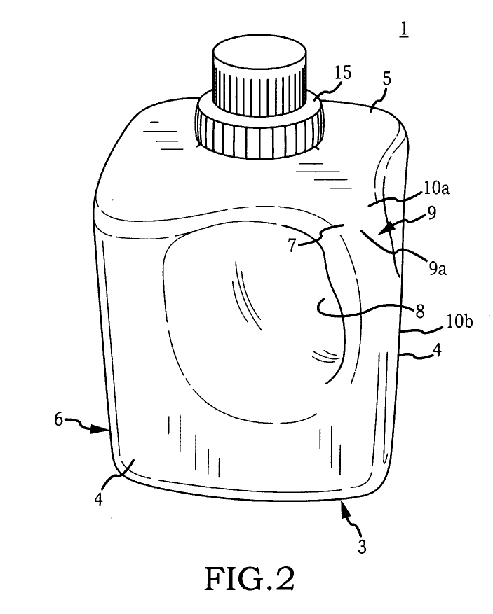

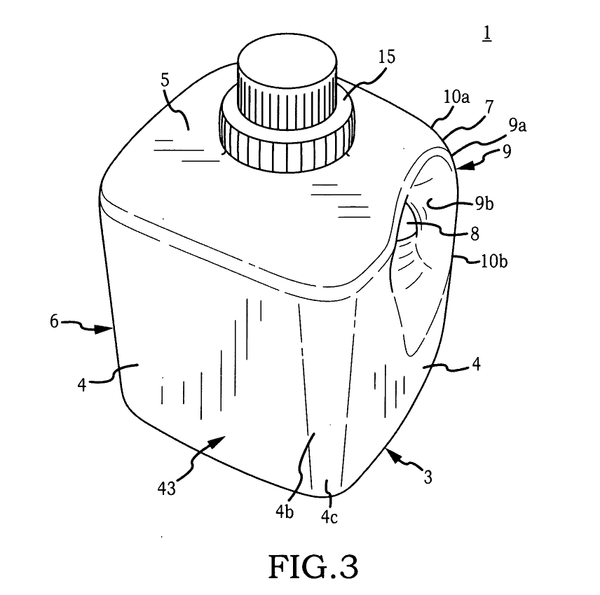

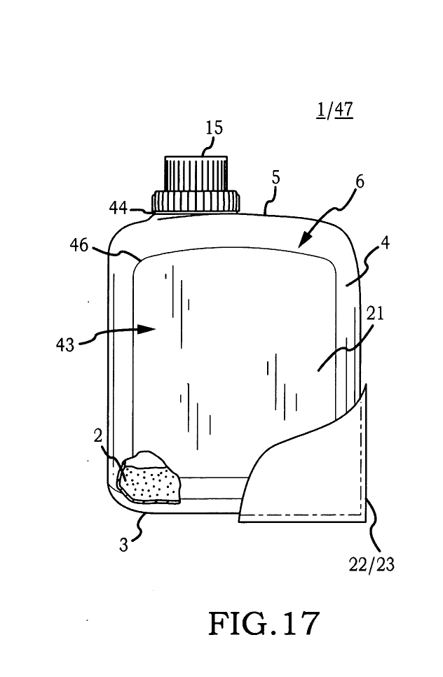

Now referring primarily to FIGS. 1-8, a particular embodiment of the inventive cubic container (1) for a liquid product (2) (see FIG. 17) has a base (3) (see FIG. 5) correspondingly joined to each of four sides (4) which generally extend vertically upwardly to join a top (5) (see FIG. 3) of generally similar dimensional relations as the base (3). The joined base (3) four sides (4) and the top (5) generally defining the internal configuration and volume of a generally cubic container body (6).

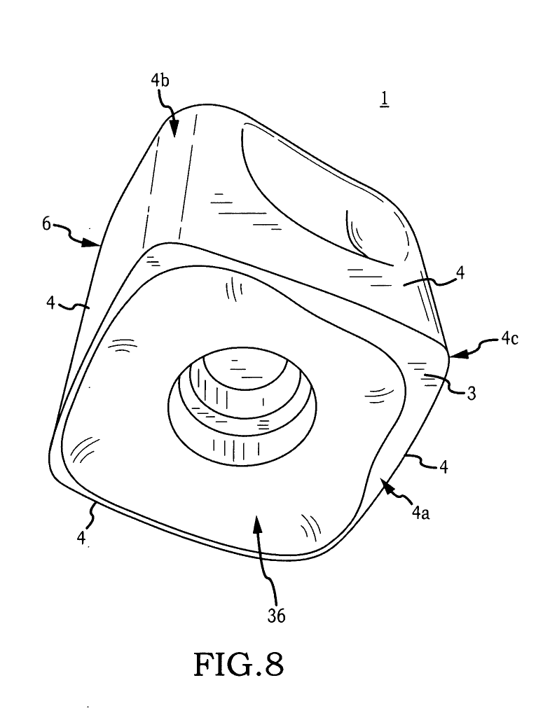

Now referring primarily to FIG. 8, it can be appreciated that the base (3) can have a generally square configuration. The term “generally square” for the purposes of the invention means a base which typically has ratio of the width to the length of about 1:1; although the ratio may vary incrementally between about 0.85:1.0 and about 1.0:0.85 and may include in any one or each of the four sides (4) a gentle outward curvature (4a), a radius (4b) which accompanies the transition between the base (3) and each of four sides (4), the top (5) and each of four sides (4) and between intersection of any two of the four sides (4), or any three sides forming a corner (4c) each limited to the extent necessitated by the particular container molding, forming or fabrication method (such as blow molding) of producing the container body (6).

Now referring primarily to FIGS. 1-8, which show a particular embodiment of the inventive cube container (1), any one or all of the four sides (4) can have an amount of outward curvature (4a) proximate the base (3) minimized such that the sides (4) opposite the handle (9) can have a substantially flat external surface (or the flattest external surface achievable utilizing a particular molding or forming process). As to the non-limiting embodiments of the invention shown in FIGS. 1-8, the amount of curvature (4a) of the sides (4) proximate the base (3) can define a radius in a range of about 15 inches to about 17 inches, and as to the particular embodiment of the cubic container (1) shown in FIG. 1 about 15.9 inches. The radius (4b) which accompanies the transition between the base (3) and each of four sides (4), the top (5) and each of four sides (4) and between the intersection of any two of the four sides (4) can be in the range of about 0.30 inches and about 0.5 inches. As to the embodiment of the invention shown in FIG. 1 the transition between the top (5) with any of the four sides can have a radius of about 0.42 inches; however, the transition between the top (5) and the two sides which include the handle (9) can have radius which increases gradually within the range approaching the transition between the top (5) and the upper handle end (10a). The intersection of any two sides (4) and the base (3) can produce a corner (4c) having a radius in the range of about 0.6 inch and about 1 inch. As to the non-limiting embodiment of the invention shown in FIG. 1, the corners (4c) which include the base (3) can have a radius falling in the lower portion of the range and the corners (4c) which include the top (5), falling in the higher portion of the range.

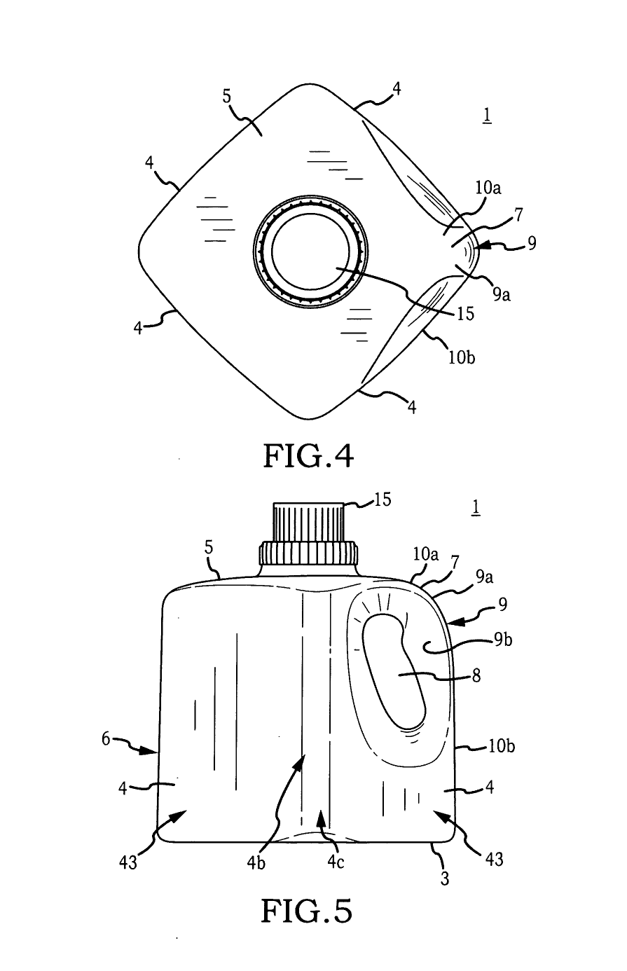

The base (3) of the non-limiting example of the cubic container (1) shown in FIGS. 1-8 can have external dimensions measured across the base (3) between the midpoint of each of two of the four sides (4) (opposed sides) of about six inches by about six inches; however, the invention is not so limited and particular embodiments of the invention can include an external dimension measured across the base (3) between the midpoints of two of the four sides (4) (opposed sides) in the range of about three inches and about ten inches as long as the base (3) remains generally square, subject to the curvature above described. At least those two of the four sides (4) which are not joined to the handle (9) can have dimensional relations which bound a generally square external surface (as shown for example in FIGS. 1, 3 and 6). For the purposes of this invention, the term “generally square” means a ratio of width to height in the range of between about 0.7:1 to about 1.1:1 with respect to at least one of the four sides (4), or the two of four sides (4) not joined to the handle (9), or of all four sides (4) with a portion of two of the four sides (4) providing a pass-through aperture (8) which defines the external configuration of a generally vertical handle (9). As a non-limiting example, the four sides (4) of the embodiment of the cubic container shown in FIGS. 1-8, have a ratio of width to height of about 1:1 (two of the sides further comprising the pass-through aperture (8) which defines the handle (9)). However, the ratio of width to height can be adjusted incrementally within the range to provide sides (4) having a width to height ratio of about 0.75:1.0, about 0.8:1.0, about 0.85:1.0, about 0.90:1.0, about 0.95:1.0, about 1.0:1.0, about 1.05:1.0 or about 1.1:1.0 (correspondingly the width could be fixed at 1.0 and the height adjusted in relation to the width with in a range of 1.0:0.75 and 1.0:1.1). The top (5) will generally have dimensions substantially similar to the base (3), thereby allowing the sides to remain disposed in substantially vertical relation to the base (3) (see for example FIG. 4).

The external configuration of the container body (6) defines an internal volume which varies in relation to the dimensions of the base (3), the four sides (4) and the top (5) of the container body (6) typically in the range of about 70 ounces (about 2,070 milliliters (“mL”)) to about 600 ounces (about 17,744 mL); however, the invention is not so limited and any particular internal volume can obtained by incrementally adjusting the dimensions of the base (3) within the typical range of about 3 inches and about 10 inches in relation to the four sides (4) and the top (5) while retaining the generally cubic configuration of the inventive container, as above described.

Now referring primarily to FIGS. 1, 4 and 5, embodiments of the cubic container (1) can further include a handle (9) which can have a hollow interior which communicates with the internal volume of the container body (6). The outward external surface (9a) of the handle (9) formed by the corner (7) (at which two sides (4) and the top (5) intersect) and the proximate intersection of two sides (4) of the container body (6) and the inward external surface (9b) defined by a pass-through aperture (8). The particular pass-through aperture (8) shown in FIGS. 1, 4 and 5 has a configuration which provides an upper handle end (10a) with an inward external surface (9b) proximate the top (5) and a bottom handle end (10b) with the inward external surface (9b) at the bottom handle end (10b) located about three inches from the base (3) providing an inwardly facing external surface (9b) between the upper handle end (10a) and the lower handle end (10b) typically having a length which falls in the range of about two and one half inches to about four inches. As shown in FIGS. 1 through 8 the constructional form of the handle (9) does not substantially alter the generally cubic configuration of the container. The inwardly facing external surfaces (9b) of the handle (9) can be configured to be readily grasped by the hand.

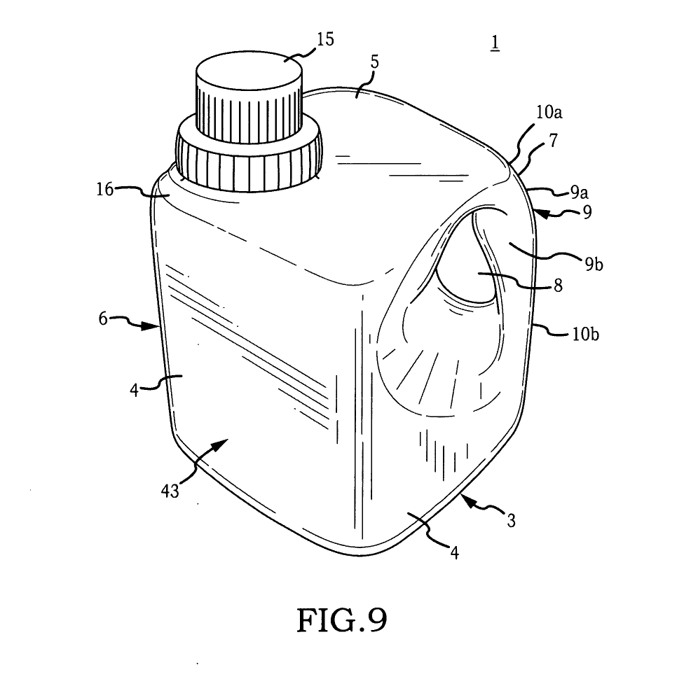

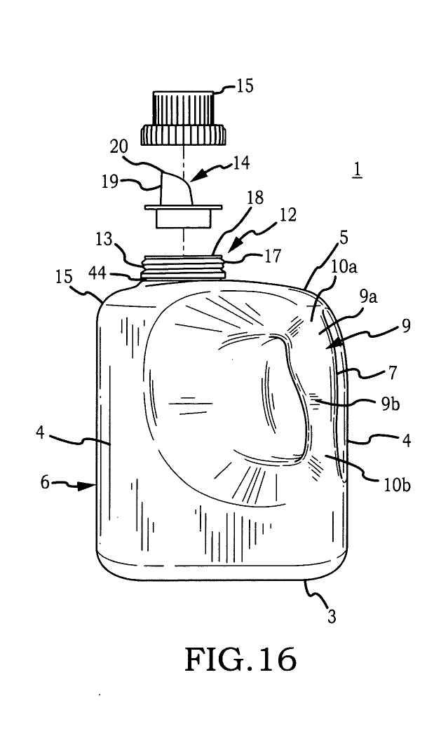

Now referring primarily to FIGS. 1-7 and 16, a generally circular opening (12) in the top (5) can be sufficiently large to dispense a liquid product (2) from within the internal volume of the container (see for example the embodiment of FIG. 16). A rim (13) extending upwardly from the circular opening (12) can be configured to receive a pour spout (14) and a cap (15). While the embodiment of the circular opening (12) shown by FIGS. 1-7, locates the circular opening (12) substantially at the center of the top (5) (for example as shown in FIG. 4), the invention is not so limited, and the circular opening (12) (and the associated rim (13)) (for example as shown in FIG. 9) can be located a distance off center toward one corner (7) or one edge (16) at which one of four sides (4) intersects the top (5) as shown as a non-limiting example in FIGS. 9 through 17. Now referring primarily to FIGS. 16 and 17, the rim (13) can receive a removably sealable cap (15). Certain embodiments of the rim (13) and the cap (16) can rotatingly engage by mated spiral threads (17).

Now referring primarily to FIG. 16, certain embodiments of the circular opening (12) can be configured to receive a pour spout (14) having a circular spout base (18) which can be sealable fitted to the corresponding engaged surfaces of the rim (13). An upwardly rising spout (19) which terminates in a leading edge (20) over which liquid products (2) contained within the internal volume of the container body (6) can be poured. The cap (15) can be configured to be received by the rim (13) containing the pour spout (14) within.

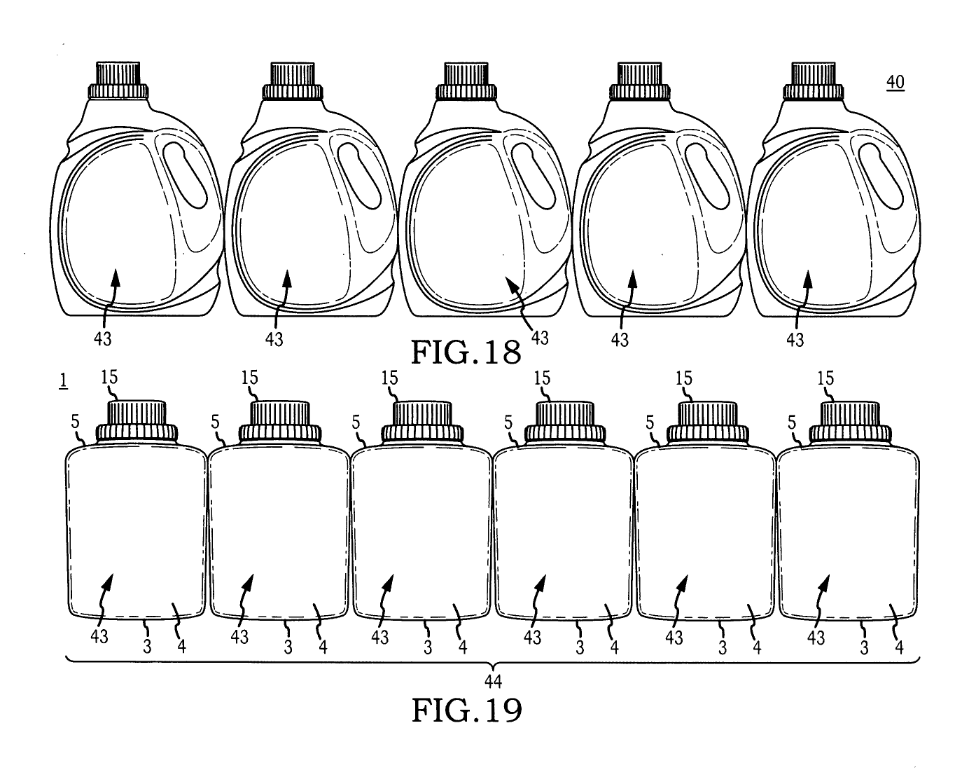

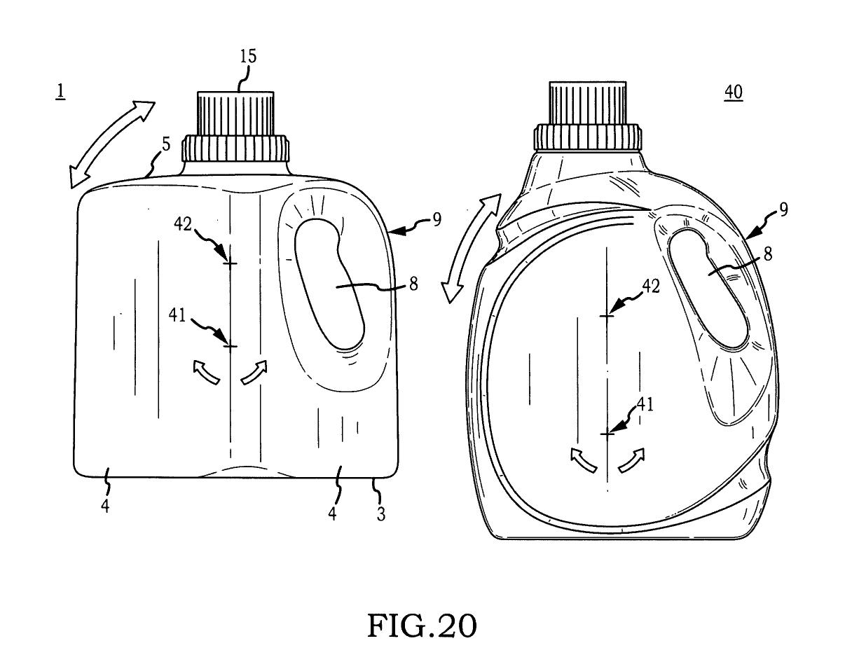

Embodiments of the inventive cubic container (1) including the handle (9) as above-described and as shown in FIGS. 1-16 confers certain advantages in handling the cubic container (1) (with or without liquid product (2) contained within) and in dispensing liquid products (2) from the cubic container (1), as compared to conventional containers (40) (for example as shown in FIG. 18) such as those shown in FIG. 18. Now referring primarily to FIG. 20, an embodiment of the inventive cubic container (1) compared with the example of a conventional container (40) (also shown in FIG. 18) shows that the center of mass (41) of the conventional container (40) is located at greater distance from the grippable portion of the handle (9) than in the embodiment of the inventive cubic container (1). That is, embodiments of the cubic container (1) have center of mass (41) which is closer to the grippable portion of the handle (9) than is provided by conventional containers (40).

The center of mass (41) is the point where all of the mass of the object is concentrated. When an object is supported at its center of mass (41) there is no net torque acting on the body and it will remain in static equilibrium. If the object is uniform, for example a meter stick, the center of mass (41) will be at the exact geometric center; if the object is irregular in shape the center of mass (41) will be closer to the heavier end. Because the inventive cubic container (1) has a center of mass (41) located closer to the grippable portion of the handle (9), a lesser net torque acts on the handle (9) and therefore less effort is required to rotate the inventive cubic container (1) as compared to the conventional container (40).

Additionally, when liquid product (2) is poured from the conventional container (40), the conventional container (40) is rotated about a pouring axis (42) defined by the dimensional relations of the spout (19), the handle (9) and the configuration of the conventional container (40). The pouring axis (42) of a conventional container (40) may be a substantial distance from the center of mass (41). Accordingly, when liquid product (2) is poured from a conventional container (40), the conventional container (40) rotates about the pouring axis (42) and sufficient force must be applied to move the center of mass (41) of the conventional container (40) about the pouring axis (42) from a first location to a second location which allows the liquid product (2) to be poured. The further the center of mass (41) occurs relative to the pouring axis (42), the more effort may be required to rotate the conventional container (40) about the pouring axis (42). For example, if a container were spherical in shape the pouring axis (42) and the center of mass (41) would occur proximate the other. As the spherical container rotates about the pouring axis (42), the center of mass (41) would move only slightly in space as compared to a rectangular container having the handle (9) and spout located proximate one end which would require substantial movement of the center of mass (41) in space to achieve pouring of a liquid product (2) from within. Additionally, because the center of mass (41) occurs at a greater distance from the handle (9) of the conventional bottle (40) once in motion the mass of the container has greater torque about the pouring axis and can be more difficult to control in regard to travel speed, direction of travel, to put in motion, or to put at rest, than compared to the inventive cubic container (1).

Embodiments of the inventive cubic container (1), which utilize a pass-through aperture (8) to configure and locate the handle (9) as shown for example by FIGS. 1-16 and as above-described, can reduce the distance between the pouring axis (42) and the center of mass (41) by maintaining the ratio of height to width of each side (4) and the base (3) and the top (5) as above described, or as to a particular embodiments of the cubic container (1) adjusts the ratios of the base (3), four sides (4) and the top (5) with respect to the handle (9) as above-described to locate the handle (9) closest to the center of mass (41) of the inventive container, or as close as a particular method of forming, molding, or fabricating or configuration may allow.

Now referring to primarily to FIGS. 1, 18 and 19, an additional advantage of the inventive cubic container (1) is illustrated by comparison of a plurality of conventional containers (40) placed in adjacent horizontal relation with the face of the container having the billboard (43) of greatest viewable area (see FIG. 18) with a plurality of cubic containers (1) produced in accordance with the invention placed in adjacent horizontal relation with one of the sides of the container having the billboard (43) of greatest area viewable (see FIG. 19). The term “billboard” for the purposes of this invention means the substantially flat area of a side (4) directly imprintable or on which a label can be affixed (for example FIG. 1 provides a label (46) applied to the billboard (43)). Interestingly, even though a greater number of cubic containers (1) produced in accordance with the invention can be placed in the same linear measure (44) as compared with conventional containers (40) (six as compared to five as shown in FIGS. 18 and 19), the billboard (43) of each inventive cubic containers (1) can have a greater area than the billboard (43) of each one of the conventional containers (40) (about 25% larger in the example provided). This is even more surprising in that conventional containers (40) such as those shown in FIG. 18 can have a greater height and width than the inventive cubic container (1).

Now referring generally to each of FIGS. 1-17 and 19 and Table 1, embodiments of the inventive cubic container (1) for a liquid product (2) can be formed, molded (such as blow molded) or otherwise fabricated from high density polyethylene (“HDPE”) as to the container body (6), polypropylene (“PP”) as to the cap (15) and pouring spout (14). The external surfaces of the cubic container (I) and in particular the billboard (43) can be imprinted directly or by application of imprinted materials (21) to any of the four sides and overwrapped with corrugated cardboard (22) to provide the shipping carton (23). Understandably, other materials compatible with particular methods of producing embodiments in accordance with the invention and compatible on contact with liquid product (2) can be utilized to form, mold or otherwise fabricate container in accordance with the invention.

Now referring to Table 1, which shows the amount of material used to produce an embodiment of the inventive cubic container (1) (referring to Table 1, column labeled “CUBIC PACKAGE”) as shown by FIGS. 1-9 having an internal volume of about 100 ounce by comparison the amount of material used to produce a conventional container (40) for a liquid product (2) having an internal volume of about 100 ounces (referring to Table 1, column labeled “CONVENTIONAL CONTAINER”) in the configuration shown in FIG. 18 or similar configurations. For each, the mass and type of material (including post consumer recycled “PCR”) is itemized.

TABLE 1
COMPARISON OF MASS OF MATERIALS
UTILIZED TO PRODUCE.

| | CONVENTIONAL | | | |
|---|---|---|---|---|
| | CONTAINER | | CUBIC PACKAGE | |
| | Material | Mass* | Material | Mass* |
| Part | Specs | (g) | Specs | (g) |
| Container Body | HDPE | 145 | HDPE | 130 |
| | 20% PCR | | 25% PCR | |
| Spout | PP | 14.2 | PP | 14.2 |
| Measuring Cap | PP | 18.5 | PP | 18.5 |
| Labels | Coated | 7 | Coated | 7 |
| | Paper | | Paper | |
| Shipping | Corrugated | 455 | Corrugated | 389 |
| Container/Overwrap | Cardboard | | 100% PCR | |

*Mass in grams may vary between embodiments of the cubic container and embodiments of the conventional container; however, for similar volume containers between the conventional container above-described and the cubic container there can be a substantial reduction in the mass of each material used as to the container body and the shipping container (also referred to as the “overwrap”).

As can be understood from the data set out in Table 1, the cubic container (1) affords an advantage in that a lesser amount of certain materials can be used in producing embodiments in comparison to conventionally configured containers. By comparison, the amount of mass of HDPE utilized in producing the container body (6) of the inventive cubic container (1) can be reduced by about 10%, or an even greater weight percent. Additionally, the amount of post consumer recycled (“PCR”) HDPE can be increased which reduces the amount of virgin HDPE resin which is utilized to produce embodiments of inventive container body (6). Additionally, the amount of overwrap (in the instant comparison “cardboard”) can be substantially reduced.

Again referring primarily to FIGS. 1-17 and 19 and to Table 2, environmental impact reductions can be directly related to the dematerialization of the container body (6) and to the shipping carton (23). As a non-limiting example, the conventional bottle design, as above described, requires about 145 grams of HDPE to provide a conventional container body with sufficient structural integrity to contain 100 ounces of liquid product. By comparison, the container body (6) of the embodiment of the inventive cubic container (1) shown in FIG. 1 capable of containing 100 ounces of the same liquid product can be provided using only 130 grams of HDPE, a 10.3% reduction in HDPE plastic resin. As another non-limiting example, the cubic container (1) requires a smaller shipping carton (23) for shipment to retailers. The cubic container (1) encloses more volume of liquid product in a smaller space, resulting in a more efficient use of space. This results in a reduction in dimensions of the shipping carton (23) from about 972 square inches to about 832 square inches of surface area. Additionally, the overall weight of the shipping carton (23) for the cubic eco-package (47) (being the cubic container and overwrap) was reduced 14.3 percent, from 454 grams to a lighter 390 grams. The more efficient shipping configuration and the corresponding reduction in weight can results in the improved overall environmental impacts of the cubic eco-packaging system as set out in Table 2.

TABLE 2
COMPARISON OF ENVIRONMENTAL IMPACTS.

| | CONVENTIONAL | ECO- | Net Benefit |
|---|---|---|---|
| ENVIRONMENTAL IMPACTS | CONTAINER | PACKAGE | (%) |
| Resource Consumption- Energy (MJ) | 19.1 | 17.4 | 9 |
| Resource Consumption- Water (kg) | 2.65 | 2.44 | 8 |
| Global Warming (kg CO₂ eq) | 0.599 | 0.527 | 12 |
| Ozone Depletion (kg r-11 eq) | 4.52E−08 | 4.1E−08 | 10 |
| Human Health- Respiratory (kg PM_{2.5}) | 7.83E−04 | 7.14E−04 | 9 |
| Acidification (kg SO₂ eq) | 2.43E−03 | 2.22E−03 | 9 |
| Water Eutrophication (kg PO₄ eq) | 1.73E−04 | 1.60E−04 | 7 |
| Photochemical Smog (kg ethene eq) | 2.87E−04 | 2.61E−04 | 9 |

Again referring primarily to FIGS. 1-17 and 19 and Table 3, embodiments of the cubic container (1) as compared to the conventional containers above described can be produced with an increased amount of PCR material. As a non-limiting example, while HDPE resin for use in production of the conventional container body may be sourced from about 20% by weight PCR content, the HDPE resin for use in production of the cubic container (1) can be sourced from about 25% to about 30% PCR content, thereby requiring as much as 10% less virgin HDPE resin use. Likewise, shipping cartons (23) for conventional containers for liquid product may be 40% PCR content while shipping container for the cubic container (1) (cubic eco-package which further includes the packaging materials) can be made of at least 80% PCR content, again preventing the use of approximately 0.4 lbs of virgin corrugated per shipping carton (23).

TABLE 3
COMPARISON OF PCR MATERIAL.

| | CONVENTIONAL | |
|---|---|---|
| Criteria | PACKAGING | ECO-PACKAGING |
| Container Body | 20% PCR | 25% PCR |
| Shipping Carton | 40% PCR | 80% PCR |
| Cap/Insert - recycled content | 0% | 0% |

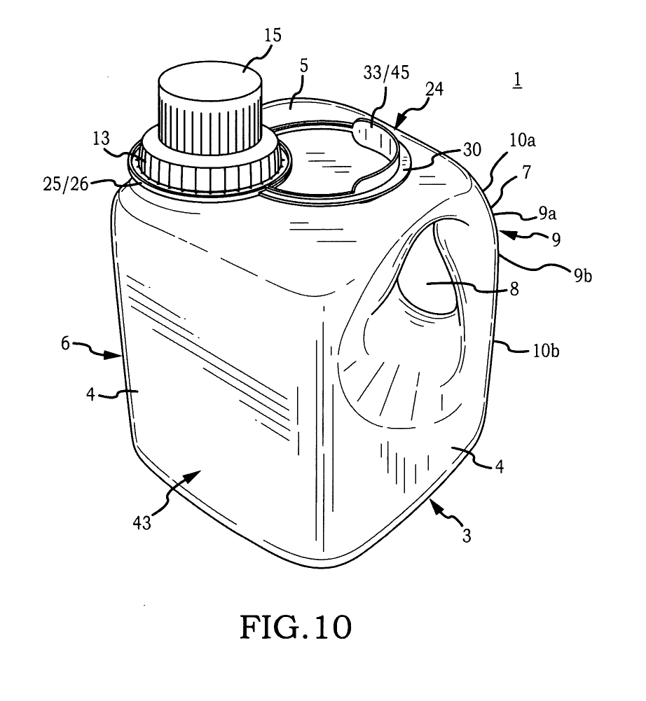

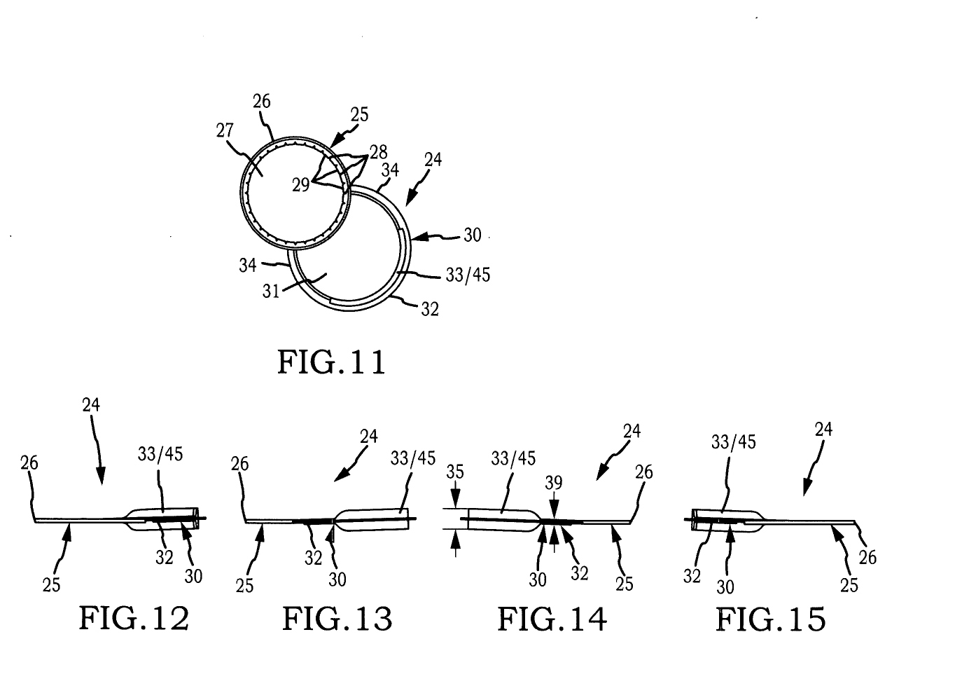

Now referring primarily to FIGS. 10-15, embodiments of the inventive cubic container (1) can further include a finger engageable pull (24). The finger engageable pull (24) can provide a container engagement portion (25) which can be configured to locate about the rim (13) (also referred to as the “neck”) of the cubic container (1) (see for example FIG. 10). The rim (13) of the cubic container (1) can receive the cap (15) to secure the container engagement portion (25) of the finger engageable pull (24) between corresponding portions of the container body (6) and the cap (15). As one non-limiting example, the rim (13) of the cubic container (1) can be circular or tubular in configuration and may further provide spiral threads (17) on the external surface by which the cap (15) rotatingly secures to the rim (13). As to these embodiments of the cubic container (1), the container engagement portion (25) of the finger engageable pull (24) can provide an annular member (26) which defines an aperture element (27) (see for example FIG. 11) through which the rim (13) (or neck) of the cubic container (1) can pass to locate the container engageable portion (25) against the container body (6) (see for example FIG. 10). The cap (15) can then be received by the rim (13) to limit subsequent axial travel of the finger engagable pull (24) along the rim (13) while allowing rotational travel of the finger engageable pull (24) about the rim (13). The container engageable portion (25) can further provide a plurality of circumferentially inward radial projections (28) coupled to the annular member (26) (see for example FIG. 11). The plurality of circumferentially inward radial projections (28) can be sufficiently flexible upon contact with the rim (13) of the cubic container (1) to allow the rim (13) to pass through the aperture element (27) of the annular member (26). The inward radial projections (28) can be sufficiently resiliently flexible upon passing of the rim (13) through the aperture element (27) to return to a generally flat condition with the terminal portion (29) of each inward radial projection (28) proximate the external surface of the rim (13) (or within a mateable annular slot (44) (see for example FIGS. 16 and 17) of the container body (6)) or forcibly urged by resilient flexure against the external surface of the rim (13). Understandably, the container engageable portion (25) can be configured to couple to a numerous and wide variety of rim (13) configurations which may be utilized with the cubic container (1). The container engageable portion (25), depending on the application, can be dimensionally adjusted to the corresponding configuration of the cubic container (1) and the mass of the cubic container or the cubic container containing the liquid product (2).

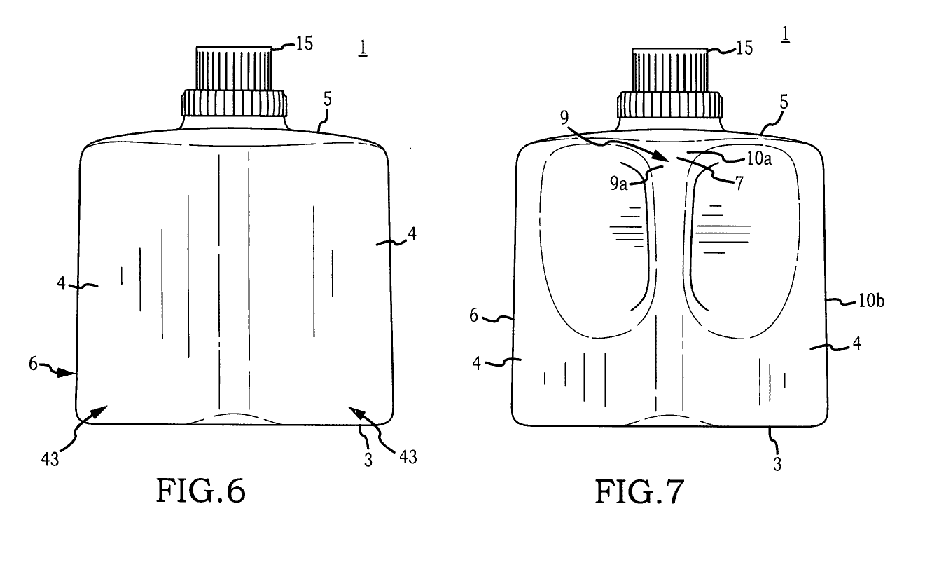

The finger engageable pull (24) can further provide a finger engageable portion (30) coupled to the container engageable portion (25). The finger engageable portion (30) can be of numerous and varied configurations which define a finger engageable aperture element (31). As one non-limiting example, the finger engageable portion (30) (see for example FIG. 6) can generally provide a finger engagable annualar member (32) (including as non-limiting examples those embodiments which provide a part of a finger engagable annular member as shown in FIGS. 6-10) which defines a finger aperture element (31) (see for example FIG. 6) of sufficient dimension to allow one or more or all of four fingers of a hand to pass through for grippable engagement with the finger engageable portion (30). A non-limiting embodiment of the finger engageable portion (30) can define a generally circular finger aperture element (31) (see for example FIG. 11). The finger engageable portion (30) can further include a finger contact element (33) configured to increase the area of contact between the finger engageable portion (30) and the fingers of the hand (not shown) to reduce the amount of force transmitted per unit area of the fingers from the finger engageable portion (30). An embodiment of the finger contact element (33) couples an elongate curved member (45) (see for example FIGS. 10-15) in substantially perpendicular relation to the inside circumference of the finger engageable portion (30). The width (35) (see for example FIG. 14) of the elongate curved member being substantially greater than the thickness (39) (see for example FIG. 14) of the finger engageable annular member (32). Thereby, upon contact with the fingers of the hand, the amount of force applied per unit area of the fingers by the finger engageable portion (30) can be substantially less. While the embodiments of the finger contact element (33) can include a thickened portion of the finger engageable annular member (32), there is an advantage in using the constructional form or similar constructional forms as shown in FIGS. 11-15 in that less material can be used to generate the elongate curved member than in generally thickening the finger engageable annular member (32).

Now referring primarily to FIG. 11, the finger engageable pull (24) can further include a flexible hinge element (34) between the finger engageable portion (30) and the container engagement portion (24). The flexible hinge element (34) allows the finger engageable portion (30) to travel in relation to the container engagement portion (25) to allow finger engagement of the finger engageable portion (30) over a wide range of positions of the fingers in relation to the cubic container (1). As a non-limiting examples, when the finger engageable pull (24) is used to remove the cubic container (1) from a shelf, the fingers may have a location proximate one of the sides (4) of the cubic eco-package (1) and when the finger engageable pull (24) is used to carry the cubic container (1) the fingers may have a location proximate the top (5) of the cubic container (1). Accordingly, the flexible hinge element (34) allows the finger engageable portion (30) to be located within a range of positions useful in handling the cubic container (1). The flexible hinge element (34) can be integral with the finger engageable portion (30) (see for example FIGS. 10 and 11).

Now referring primarily to FIG. 8, the cubic container (1) can further provide a base recess element (36) having a configuration which slidely receives the cap (15) upon stacking of a first cubic container (1) on top of a second cubic container (1). This confers the advantage of increased stability of stacked cubic containers (1) and the further advantage of locating an equivalent or greater number of cubic containers (1) in the same or lesser space or volume in storage or within a shipping carton (23).

As can be easily understood from the foregoing, the basic concepts of the present invention may be embodied in a variety of ways. The invention involves numerous and varied embodiments of a cubic container for liquid products (including a eco-package system) including the best mode as above described.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “container” should be understood to encompass disclosure of the act of “containing”—whether explicitly discussed or not—and, conversely, were there effectively disclosure of the act of “containing”, such a disclosure should be understood to encompass disclosure of a “container” and even a “means for containing.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the substantially cubic containers herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A cubic container for a liquid product, comprising;
a) a base having a generally square configuration;
b) four sides each of which correspondingly join with one edge of said base in substantially vertical relation, each said four sides having a generally square configuration;
c) a top having dimensions substantially similar to said base which joins with each of said four sides generally defining an internal volume of a container body;
d) a substantially vertical handle having an external surface configuration defined by an intersection of two of said four sides and a pass-through aperture, said handle having a hollow interior which communicates with the internal volume of said container body; and
e) an opening in said top; and
f) a cap removably sealably engagable with said opening.

2. The cubic container for a liquid product as described by claim 1, wherein each one of said four sides has a ratio of a width to a height selected from the group including about 0.75:1.0, about 0.8:1.0, about 0.85:1.0, about 0.90:1.0, about 0.95:1.0, about 1.0:1.0, about 1.05:1.0, about 1.1:1.0, about 1.15:1.0, about 1.2:1.0, and about 1.25:1.0.

3. The cubic container for a liquid product as described by claim 2, wherein said pass-through aperture has dimensions sufficient to allow a portion of a hand to pass through said pass-through aperture for engagement of a portion of hand with a portion said handle.

4. The cubic container for a liquid product as described by claim 3, wherein said pass-through aperture has a location which locates an upper end of said handle proximate said top.

5. The cubic container for a liquid product as described by claim 3, wherein said pass-through aperture has a location between said top and said base of said cubic container which locates said portion of said handle engageable with said portion of said hand closest to a center of mass of said cubic container.

6. The cubic container for a liquid product as described by claim 5, further comprising an amount of liquid product which substantially fills said internal volume of said cubic container.

7. The cubic container for a liquid product as described by claim 3, wherein said pass-through aperture locates said portion of said handle engageable with said portion of said hand at a location between said top and said base of said cubic container which generates a pouring axis closest to a center of mass of said cubic container.

8. The cubic container for a liquid product as described by claim 1, further comprising a bottom recess element coupled to said base of said container body, said bottom recess element configured to allow a first cubic container to stack on a second cubic container with at least a portion of the cap of said second cubic container received within said bottom recess element of said first cubic container.

9. The cubic container for a liquid product as described by claim 1, further comprising a billboard comprising substantially the entirety of the external surface area of either of two sides of said container body opposite said handle, said billboard providing a generally square continuous surface area sufficiently flat to imprint or to fix imprinted material.

10. The cubic container for a liquid product as described in claim 1, further comprising a finger engageable pull coupled proximate said top of said container body.

11. A method of producing a cubic container, comprising the steps of:
a) providing a base having a generally square configuration;
b) joining a side to each edge of said base, each said side having a generally square configuration;
c) joining a top having dimensions substantially similar to said base to said four sides to define an internal volume of said cubic container;
d) generating a handle having a hollow interior which communicates with said internal volume of said cubic container, said handle having an external configuration defined by the intersection of two of said four sides and a pass-through aperture which communicates between intersecting said two of four sides;
e) providing an opening in said top; and
f) providing a top removably sealable with said opening.

12. The method of producing a cubic container of claim 11, further comprising the step of selecting a ratio of a width to a height of each of four sides from the group including about 0.75:1.0, about 0.8:1.0, about 0.85:1.0, about 0.90:1.0, about 0.95:1.0, about 1.0:1.0, about 1.05:1.0, about 1.1:1.0, about 1.15:1.0, about 1.2:1.0, and about 1.25:1.0.

13. The method of producing a cubic container of claim 11, further comprising the step of dimensionally configuring said pass-through aperture to allow a portion of a hand to pass through said pass-through aperture for engagement with a portion of said handle.

14. The method of producing a cubic container of claim 13, further comprising the step of locating said pass through aperture to establish an upper end of said handle proximate said top.

15. The method of producing a cubic container of claim 14, further comprising the step of providing said portion of said handle engageable with said portion of said hand between said top and said base at a location closest to a center of mass of said cubic container.

16. The method of producing a cubic container of claim 15, further comprising the step of establishing within said cubic container an amount of liquid product which substantially fills said internal volume of said cubic container.

17. The method of producing a cubic container of claim 15, further comprising the step of providing said portion of said handle engageable with said portion of said hand between said top and said base at a location which generates a pouring axis closest to said center of mass of said cubic container.

18. The method of producing a cubic container of claim 15, further comprising the step of recessing said base of said container body to allow a first cubic container to stack on a second cubic container with at least a portion of said cap of said second cubic container received within a base recess element of said first cubic container.

19. The method of producing a cubic container of claim 15, further comprising the step of establishing a billboard comprising substantially the entirety of the external surface area of either of two sides of said container body opposite said handle, said billboard providing a generally square continuous surface area sufficiently flat to imprint or to fix imprinted material.
